(19) United States
(12) Patent Application Publication
(10) Pub. No.: US 2011/0069855 A1
(43) Pub. Date: Mar. 24, 2011

(54) ELECTRONIC APPARATUS

(75) Inventors: Tatsuhiko Tokuda, Kanagawa (JP); Tomoya Kimura, Kanagawa (JP); Teruyasu Sada, Kanagawa (JP)

(73) Assignee: Panasonic Corporation, Osaka (JP)

(21) Appl. No.: 12/994,121

(22) PCT Filed: Jan. 27, 2009
(86) PCT No.: PCT/JP2009/000296

§ 371 Date: Nov. 22, 2010

(30) Foreign Application Priority Data
May 28, 2008 (JP) 2008-139792

(51) Int. Cl. H04R 1/02

(52) U.S. Cl. 381/334

(57) ABSTRACT

Disclosed is an electronic apparatus which can ensure waterproofness or dustproofness when a rectangular electroacoustic transducer is employed, and can prevent both distortion of voice and leakage of sound at the same time. A first casing (101) of the electronic apparatus has sound holes (110). A film member (103) is substantially circular and provided between the sound holes (110) and an electroacoustic transducer (107). A planar member (105) is provided between the film member (103) and the electroacoustic transducer (107) and has second sound holes (111). The electroacoustic transducer (107) is substantially rectangular and generates voice.

### TECHNICAL FIELD

The present invention relates to an electronic device, and relates, for example, to an electronic device that waterproofs an electroacoustic transducer provided inside a casing.

### BACKGROUND ART

Hitherto, a telephone provided with a waterproof film for waterproofing an acoustic part has been known (see Patent Literature 1, for example).

FIG. 1 is an exploded perspective view of principal parts of conventional electronic device 1 such as a telephone. Conventional electronic device 1 mainly comprises casing 10, cushion member 11, film member 12, cushion member 13, and electroacoustic transducer 14.

Casing 10 has plurality of sound holes 50, which are through-holes. Sound holes 50 output speech generated from electroacoustic transducer 14 to the exterior of casing 10.

Cushion member 11 is provided between casing 10 and film member 12, and provides a seal between casing 10 and film member 12.

Film member 12 is circular viewed from above, and is provided between cushion member 11 and cushion member 13. Film member 12 prevents water or other liquids from penetrating into the interior of casing 10 from sound holes 50.

Cushion member 13 is provided between film member 12 and electroacoustic transducer 14, and provides a seal between film member 12 and electroacoustic transducer 14.

Electroacoustic transducer 14 is a speaker, for example.

In recent years, as portable terminals such as mobile phones have become smaller in size, rectangular electroacoustic transducers have been used in order to achieve an efficient parts layout inside the casing.

### CITATION LIST

### Patent Literature

### [PTL 1]

Japanese Patent Application Laid-Open No. HEI8-79865

### SUMMARY OF INVENTION

### Technical Problem

However, if a film member is made rectangular in line with the shape of a rectangular electroacoustic transducer, distances from the center of the surface of the film member to the sides become unequal. Consequently, when the film member vibrates due to speech generated from the electroacoustic transducer, there is a problem of frequency components of various different frequencies being produced, and speech output from the sound holes in the casing being distorted.

On the other hand, if a round film member is used in the conventional way, speech distortion does not occur since distances from the center of the surface of the film member to peripheral edges become equal. However, if a round film member is still used even though the electroacoustic transducer has been made rectangular, there is a problem of sound leakage occurring due to the creation of a gap between the film member and the electroacoustic transducer.

It is an object of the present invention to provide an electronic device that can ensure waterproofing and dustproofing, and can prevent both speech distortion and sound leakage at the same time, when a rectangular electroacoustic transducer is used.

### Solution to Problem

An electronic device of the present invention employs a configuration having a casing, first sound holes provided in the casing, a substantially rectangular electroacoustic transducer provided inside the casing, a substantially circular film member provided between the first sound holes and the electroacoustic transducer, a planar member provided between the film member and the electroacoustic transducer, and second sound holes provided in the planar member.

### ADVANTAGEOUS EFFECTS OF INVENTION

The present invention can ensure waterproofing and dustproofing, and can prevent both speech distortion and sound leakage at the same time, when a rectangular electroacoustic transducer is used.

### BRIEF DESCRIPTION OF DRAWINGS

FIG. 1 is an exploded perspective view of principal parts of a conventional electronic device;

FIG. 2 is an exploded perspective view of principal parts of an electronic device according to an embodiment of the present invention;

FIG. 3 is a cross-sectional view of an electronic device according to an embodiment of the present invention;

FIG. 4 is a plan view showing the mutual positional relationship of a film member, electroacoustic transducer, and sound holes according to an embodiment of the present invention;

FIG. 5 is a plan view showing the mutual positional relationship of a film member, electroacoustic transducer, and sound holes according to an embodiment of the present invention; and

FIG. 6 is an exploded perspective view of an electronic device according to an embodiment of the present invention.

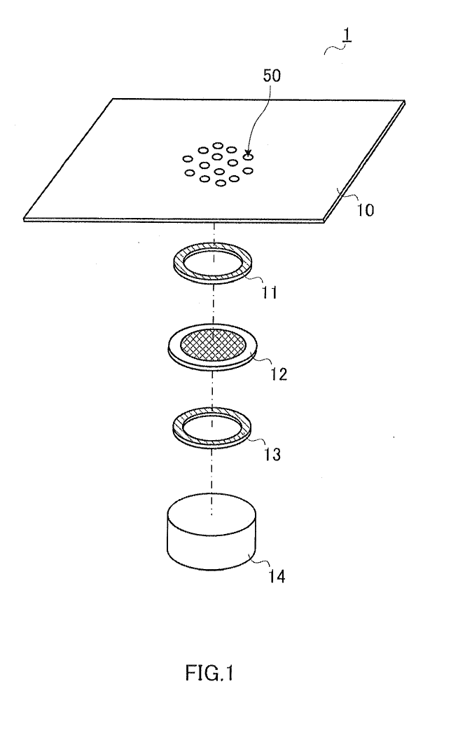

### DESCRIPTION OF EMBODIMENTS

Now, an embodiment of the present invention will be described in detail with reference to the accompanying drawings.

### Embodiment

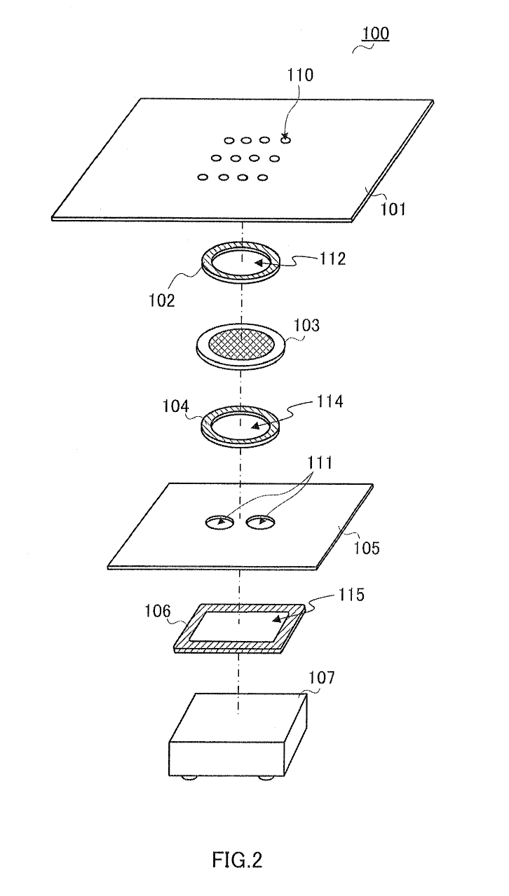

FIG. 2 is an exploded perspective view of principal parts of electronic device 100 according to an embodiment of the present invention.

Electronic device 100 mainly comprises first casing 101, cushion member 102, film member 103, cushion member 104, planar member 105, cushion member 106, and electroacoustic transducer 107. Electronic device 100 is, for example, a communication terminal apparatus such as a mobile phone, or a portable TV. Cushion member 102, film member 103, cushion member 104, planar member 105, cushion member 106, and electroacoustic transducer 107 are housed in an interior space formed by another casing described later herein that is separate from first casing 101, and first casing 101. However, in FIG. 2, only a part of first casing 101 is shown, and another casing is not shown.

First casing 101 has plurality of sound holes 110, which are through-holes.

Cushion member 102 is provided between first casing 101 and film member 103. Cushion member 102 has an adhesive section of double-sided adhesive tape or the like on its upper surface and lower surface, and creates a seal between first casing 101 and film member 103 through the adhesion of the respective adhesive sections to first casing 101 and film member 103. Cushion member 102 is circular viewed from above, and has circular through-hole 112 in its center.

Film member 103 is thin film that is approximately circular viewed from above, and is provided between cushion member 102 and cushion member 104. Film member 103 is formed from a material that allows speech generated from electroacoustic transducer 107 to pass through without being attenuated, and is, for example, a microporous membrane of PTFE or the like. Film member 103 prevents water or other liquids, or dust, that penetrates from sound holes 110, from further penetrating to electroacoustic transducer 107. That is to say, film member 103 functions as a waterproof film or dustproof film. The term “approximately circular” here includes a polygonal shape in which distances from the center to the periphery are approximately uniform, including, essentially, various shapes that are approximately circular and that do not give rise to various frequency components that cause speech distortion when they vibrate due to speech.

Cushion member 104 is provided between film member 103 and planar member 105. Cushion member 104 has an adhesive section of double-sided adhesive tape or the like on its upper surface and lower surface, and creates a seal between film member 103 and planar member 105 through the adhesion of the respective adhesive sections to film member 103 and planar member 105. Cushion member 104 is circular viewed from above, and has circular through-hole 114 in its center.

Planar member 105 is of thin planar shape, and is provided between cushion member 104 and cushion member 106. Planar member 105 has two sound holes 111, which are through-holes. The number of sound holes 111 is not limited to two, but may be three or more, or one.

Cushion member 106 is provided between planar member 105 and electroacoustic transducer 107. Cushion member 106 has an adhesive section of double-sided adhesive tape or the like on its upper surface and lower surface, and creates a seal between planar member 105 and electroacoustic transducer 107 through the adhesion of the respective adhesive sections to planar member 105 and electroacoustic transducer 107. Cushion member 106 is rectangular viewed from above, and has rectangular through-hole 115 in its center.

Electroacoustic transducer 107 is approximately rectangular viewed from above. Electroacoustic transducer 107 is a speaker, for example. In addition to a rectangular shape, the term “approximately rectangular” here includes an octagonal shape with four corners cut obliquely, for example, including, essentially, various shapes that are approximately rectangular and that enable an efficient parts layout to be achieved inside the casing.

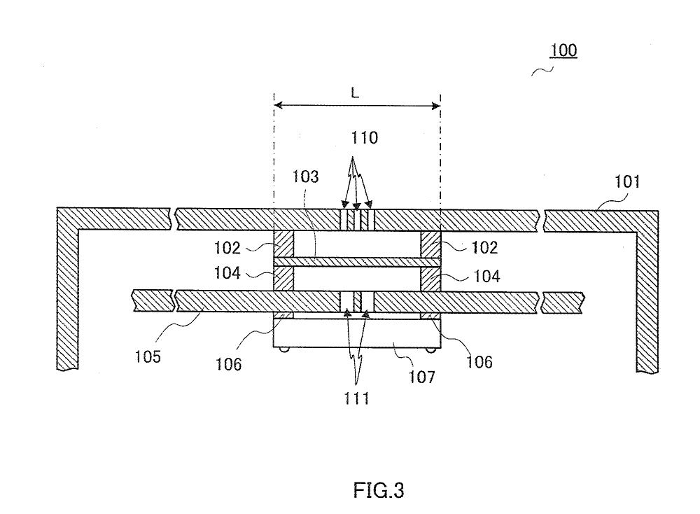

FIG. 3 is a cross-sectional view of electronic device 100. As shown in FIG. 3, inside first casing 101 of electronic device 100, electroacoustic transducer 107, cushion member 106, planar member 105, cushion member 104, film member 103, and cushion member 102 are stacked in that order. Sound holes 110 are provided in first casing 101 so as to be located within range L in which film member 103 and electroacoustic transducer 107 overlap in a plan view (looking downward from above in FIG. 3). Similarly, sound holes 111 are provided in planar member 105 so as to be located within range L in which film member 103 and electroacoustic transducer 107 overlap in a plan view. Also, sound holes 110 are provided at positions in which they mutually overlap with sound holes 111 in a plan view. Film member 103 is located between sound holes 110 and sound holes 111. However, since film member 103 is formed from a material that allows speech to pass through without being attenuated, speech that has passed through sound holes 111 can be guided to sound holes 110 without being attenuated.

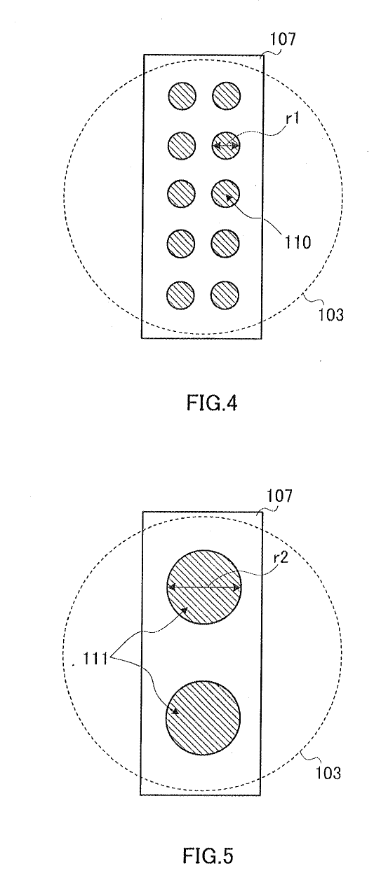

FIG. 4 is a plan view showing the mutual positional relationship of film member 103, electroacoustic transducer 107, and sound holes 110. From FIG. 4, it can be seen that sound holes 110 are located at positions in which they overlap both film member 103 and electroacoustic transducer 107 in a plan view.

FIG. 5 is a plan view showing the mutual positional relationship of film member 103, electroacoustic transducer 107, and sound holes 111. From FIG. 5, it can be seen that sound holes 111 are located at positions in which they overlap both film member 103 and electroacoustic transducer 107 in a plan view.

Sound holes 110 and sound holes 111 are formed so that the total area of sound holes 111 in the surface of planar member 105 is greater than the total area of sound holes 110 in the surface of first casing 101. By this means, speech that has passed through sound holes 111 can pass through sound holes 110 without being attenuated. Here, the total area of sound holes 110 can be found by multiplying the area of one sound hole 110 by the total number of sound holes 110. That is to say, in the case shown in FIG. 4, the total area of sound holes 110 can be found by means of equation 1.

Total area of sound holes 110 S1=((r1÷2)2×π)×10 (Equation 1)

where r1 is the diameter of sound holes 110.

Also, the total area of sound holes 111 can be found by multiplying the area of one sound hole 111 by the total number of sound holes 111. That is to say, in the case shown in FIG. 5, the total area of sound holes 111 can be found by means of equation 2.

Total area of sound holes 111 S2=((r2÷2)2×π)×2 (Equation 2)

where r2 is the diameter of sound holes 111.

By this means, sound holes 110 and sound holes 111 are formed so that S1≦S2. As long as this condition is satisfied, the shape and number of sound holes 110 and sound holes 111 are not limited to those in this embodiment.

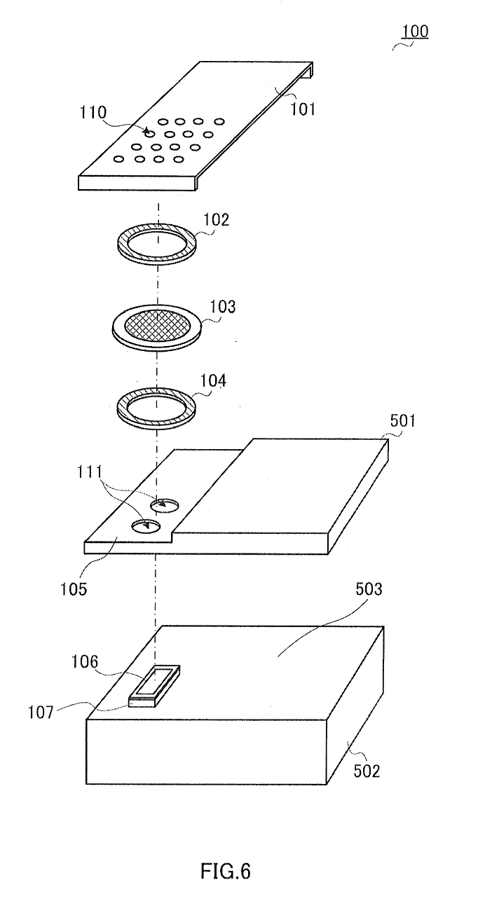

FIG. 6 is an exploded perspective view of electronic device 100. Electronic device 100 comprises first casing 101, intermediate casing 501, and second casing 502.

First casing 101 has a U-shaped cross-section and has sound holes 110. Cushion member 102, film member 103, and cushion member 104 are housed in an interior space formed by first casing 101 and intermediate casing 501.

Intermediate casing 501 has, integrally, recessed planar member 105 having sound holes 111. First casing 101 is attached to intermediate casing 501 so as to cover planar member 105. Cushion member 102 and film member 103 are placed on recessed planar member 105, and are covered by first casing 101. Intermediate casing 501 is attached to second casing 502 so as to cover the upper surface of second casing 502.

Second casing 502 has parts layout section 503 on which an electrical circuit pattern (not shown) is formed. Electroacoustic transducer 107, to which cushion member 106 is attached, is attached to parts layout section 503 and electrically connected to the electrical circuit pattern on parts layout section 503.

The method of assembling electronic device 100 will now be described using FIG. 2 and FIG. 6.

First, cushion member 106 is attached to the outer part of the upper surface of electroacoustic transducer 107, and electroacoustic transducer 107 is placed on parts layout section 503 of second casing 502 so as to be electrically connected to the electrical circuit pattern on parts layout section 503.

Next, film member 103 is attached to planar member 105 by means of cushion member 104 at a position to seal off sound holes 111.

Next, first casing 101 is attached to intermediate casing 501 so as to cover planar member 105 of intermediate casing 501. By this means, film member 103 is attached to first casing 101, by means of cushion member 102, in a position to seal off sound holes 110.

Next, intermediate casing 501 is attached to second casing 502. By this means, cushion member 106 is attached to planar member 105, and electronic device 100 is completed.

This concludes a description of the method of assembling electronic device 100.

In electronic device 100 of this kind, speech output from electroacoustic transducer 107 reaches film member 103 after passing through through-hole 115 of cushion member 106, sound holes 111, and through-hole 114 of cushion member 104, in that order. Then speech that has reached film member 103 passes through film member 103. At this time, film member 103 vibrates due to the speech passing through. Since film member 103 is circular, speech that passes through film member 103 is not distorted.

Next, speech that has passed through film member 103 passes through through-hole 112 of cushion member 102 and sound holes 110, and is output to the exterior of electronic device 100.

Water or other liquids, or dust, that penetrates into the interior of electronic device 100 from sound holes 110 passes through through-hole 112 of cushion member 102. However, water or other liquids, or dust, cannot penetrate further into the interior of electronic device 100 due to film member 103.

Thus, according to this embodiment, by providing a planar member provided with sound holes between a casing and an electroacoustic transducer, and also providing a circular film member between the casing and the planar member, waterproofing and dustproofing can be ensured, and both speech distortion and sound leakage can be prevented at the same time, when a rectangular electroacoustic transducer is used. Also, by making the total area of sound holes provided in the planar member in the surface of the planar member greater than the total area of sound holes provided in a first casing in the surface of the first casing, speech generated from the electroacoustic transducer can be output to the exterior without being attenuated. Furthermore, according to this embodiment, by providing a plurality of sound holes in the planar member, a decrease in the strength of the planar member associated with sound hole formation can be reduced.

In this embodiment, a case has been described in which electroacoustic transducer 107 is a speaker. However, the present invention is not limited to this, and can be applied to any electroacoustic transducer, such as a microphone, receiver, or the like, as well as a speaker.

In the present invention, a planar member has been assumed to be integral with an intermediate casing. However, the present invention is not limited to this, and a planar member may also be a separate entity from an intermediate casing.

In this embodiment, a seal is provided between first casing 101 and film member 103, and film member 103 and planar member 105, by means of cushion member 102 and cushion member 104 respectively. However, the present invention is not limited to this, and provision may also be made for adhesive sections enabling adhesion to first casing 101 and planar member 105 to be provided on film member 103, and for cushion member 102 and cushion member 104 to be eliminated.

The disclosure of Japanese Patent Application No. 2008-139792, filed on May 28, 2008, including the specification, drawings and abstract, is incorporated herein by reference in its entirety.

### INDUSTRIAL APPLICABILITY

The present invention is suitable for use in an electronic device such as a mobile phone, portable audio player, digital camera, digital video camera, notebook PC, electronic dictionary, portable game machine, portable TV, and so forth.

1. An electronic device comprising:
a casing;
a first sound hole provided in the casing;
an substantially rectangular electroacoustic transducer provided inside the casing;
an substantially circular film member provided between the first sound hole and the electroacoustic transducer;
a planar member provided between the film member and the electroacoustic transducer; and
a second sound hole provided in the planar member.

2. The electronic device according to claim 1, wherein the film member is provided for waterproofing for the electroacoustic transducer.

3. The electronic device according to claim 1, further comprising:
a first sealing member that is provided between the casing and the film member and provides a seal between the casing and the film member;
a second sealing member that is provided between the film member and the planar member and provides a seal between the film member and the planar member; and
a third sealing member that is provided between the planar member and the electroacoustic transducer and provides a seal between the planar member and the electroacoustic transducer.

4. The electronic device according to claim 1, wherein the electroacoustic transducer is a speaker.

5. The electronic device according to claim 1, wherein a total area of the second sound hole in a surface of the planar member is greater than a total area of the first sound hole in a surface of the casing.

6. The electronic device according to claim 1, wherein the planar member is formed integrally with the casing.
